(19) United States
(12) Patent Application Publication
(10) Pub. No.: US 2009/0218012 A1
(43) Pub. Date: Sep. 3, 2009

(54) MATERIAL FOR MAGNETIC ANISOTROPIC MAGNET

(75) Inventors: Keiko HIOKI, Showa-ku, Nagoya-shi, Aichi (JP); Takao YABUMI, Midori-ku, Nagoya-shi, Aichi (JP); Hayato HASHINO, Ohta-cho, Tokai-shi, Aichi (JP)

Correspondence Address: GREENBLUM & BERNSTEIN, P.L.C., 1950 ROLAND CLARKE PLACE, RESTON, VA, 20191, US

(73) Assignee: DAIDO STEEL CO., LTD, Aichi-ken (JP)

(21) Appl. No.: 12/392,329

(22) Filed: Feb. 25, 2009

(30) Foreign Application Priority Data
Feb. 29, 2008 (JP) 2008-049685
Jan. 7, 2009 (JP) 2009-002054

(51) Int. Cl. H01F 1/053

(52) U.S. Cl. 148/302

(57) ABSTRACT

A material for magnetic anisotropic magnet, comprising (1) a Pr-T-B—Ga-based composition containing Pr: 13.0 to 15.0 atomic percent, B: 4.5 to 6.5 atomic percent, Ga: 0.1 to 0.7 atomic percent, and the balance of. T and inevitable impurities, wherein T is obtained by substituting Co for Fe or a portion of Fe, (2) the material for magnetic anisotropic magnet is obtained by rapidly-cooling a molten alloy having the composition, pulverizing the ribbon obtained by the rapid-cooling, cold-forming the alloy powder obtained by the pulverizing, hot-forming the cold-formed body, and performing hot plastic working to the hot-formed body, and (3) the degree of magnetic orientation of the material for magnetic anisotropic magnet, which is defined by remanence (Br)/saturation magnetic flux density (Js), is 0.9 or more.

### BACKGROUND OF THE INVENTION

1. Field of the Invention

The present invention relates to a material for magnetic anisotropic magnet that can be obtained by hot plastic working.

2. Description of the Related Art

Recently, for motors or electric generators, magnets (rare-earth magnets) including rare-earth elements, such as neodymium or samarium have been widely used. The reason the rare-earth magnets are used is that they have excellent magnetic properties and are relatively inexpensive. Coercivity (iHc) and remanence (Br) are considered as important factors in the magnetic properties.

The coercivity is the magnitude of magnetic field that is needed to make magnetization zero. In general, it has been known that heat resistance is excellent when the coercivity is large.

The remanence represents the magnitude of the maximum magnetic flux density (the degree of force of a magnetic field) of a magnet material. In the case that the remanence is large, it is possible to reduce the size of the apparatuses, such as an electric generator, and the cost of the magnets, and as a result, this is considerably advantageous.

Therefore, Nd (neodymium)-Fe (iron)-B (boron) magnets having high remanence have been the most widely used as rare-earth magnets.

On the other hand, a magnet alloy that can be obtained by applying hot plastic working to R (rare-earth elements)-Fe—B-based magnetic alloys has been known in the related art (see Laying-open No. H11l(999)-329810). In Laying-Open No. H11(1999)-329810, it is described that an anisotropic magnet having excellent magnetic properties can be obtained by optimizing the composition of an R—Fe—B-based magnetic alloy and the process conditions.

Further, a magnet mainly using Pr (praseodymium) to improve coercivity has already been known (see Laying-Open No. H8(1996)-273914). In Laying-Open No. H8(1996)-273914, in consideration of ensuring workability in casting and hot rolling, and high coercivity, a magnet, in which the composition of Pr is limited within 15 to 17 atomic percent, is described (see Paragraph “0014”). Further, it has been known that a magnet having high coercivity can be obtained by applying appropriate heat treatment to a Pr—Fe—B-based alloy (see [Operation] in Laying-Open No. H2(1990)-3210)

However, magnets in the related art have the following problems for use in motors that are used in a high-temperature environment.

Technically, according to magnetic properties of rare-earth magnets containing the main component of Pr or Nd, the coercivity decreases with the increase of remanence, while the magnetic flux density decreases with the increase of coercivity, which is a trade-off relationship. It is difficult to improve both of the residual flux density and coercivity.

Therefore, the magnet described in Laying-Open No. H11(1999)-329810 improves the maximum energy product ((BH)ₘₐₓ) by particularly increasing the magnetic flux density, however, has a problem in that it can not obtain sufficient coercivity. Further, the magnets described in Laying-Open No. H8(1996)-273914 and Laying-Open No. H2(1990)-3210 can obtain high coercivity, however, has a problem in that they can not necessarily obtain sufficient remanence.
[Patent document 1] Laying-Open No. H11(1999)-329810
[Patent document 2] Laying-Open No. H8(1996)-273914
[Patent document 3] Laying-Open No. H2(1990)-3210

### SUMMARY OF THE INVENTION

An object of the present invention is to improve coercivity of a material for magnetic anisotropic magnet containing the main component of Pr, without decreasing remanence.

In order to achieve the above object, a material for magnetic anisotropic magnet according to the present invention, includes the following configuration.

(1) The material for magnetic anisotropic magnet contains a Pr-T-B—Ga-based composition containing Pr: 13.0 to 15.0 atomic percent, B: 4.5 to 6.5 atomic percent, Ga: 0.1 to 0.7 atomic percent, and the balance of T and inevitable impurities, wherein T is obtained by substituting Co for Fe or a portion of Fe.

(2) The material for magnetic anisotropic magnet is obtained by rapidly-cooling a molten alloy having the composition, pulverizing the ribbon obtained by the rapid-cooling, cold-forming the alloy powder obtained by the pulverizing, hot-forming the cold-formed body, and performing hot plastic working to the hot-formed body.

(3) The degree of magnetic orientation of the material for magnetic anisotropic magnet, which is defined by remanence (Br)/saturation magnetic flux density (Js), is 0.9 or more.

The material for magnetic anisotropic magnet may be configured such that a portion of Pr is substituted by Nd, provided that Pr is 50 atomic percent or more of all the rare-earth elements.

Further, the material for magnetic anisotropic magnet may be configured such that a portion of Pr (Nd added if necessary) is substituted by at least one element selected from a group of Dy and Tb.

Further, the material for magnetic anisotropic magnet may further contain at least one element selected from a group of Cu and Al.

Since the material for magnetic anisotropic magnet according to the present invention contains Pr as the main component, which increases coercivity more than Nd, high coercivity can be obtained. Further, since the amount of Pr is limited within 13.0 to 15.0 atomic percent, the coercivity is improved while difficulty in hot plastic working is not increased and a practical problem, such as sintered-sticking to a mold, is not generated.

The material for magnetic anisotropic magnet according to the present invention is obtained by performing cold-forming, hot-forming, and hot plastic working to alloy powder having a predetermined composition. That is, the material for magnetic anisotropic magnet is formed in a polycrystalline body having crystal grains and grain boundary phases surrounding them.

By performing hot-forming to the cold-formed body, densification proceeds and the grain boundary phase that has liquefied surrounds the crystal grains, in which the axes of easy magnetization of the crystal grains are disposed in random directions. By performing the hot plastic working to the obtained hot-formed body, the crystal grains are plastically deformed while being compressed in the pressing direction, and the axes of easy magnetization of the crystal grains are oriented in the pressing direction. As a result, the degree of magnetic orientation defined by remanence (Br)/saturation magnetic flux density (Js) becomes 0.9 or more. Further, the degree of magnetic orientation becomes 0.95 or more by optimizing the manufacturing conditions.

In the present invention, the axes of easy magnetization become easy to be oriented in a predetermined direction, with the result that the remanence can be increased. The reason is considered as follows: when Pr is used as the main component of the material for magnetic anisotropic magnet, the melting point of the grain boundary phases is relatively reduced and the crystal grains can be smoothly rotated. That is, the present invention makes it possible to improve coercivity without decreasing remanence due to specific characteristics of Pr and specific orientation mechanism of Pr during the hot plastic working.

### BRIEF DESCRIPTION OF THE DRAWINGS

FIG. 1 is a graph illustrating the relationship between Pr content and coercivity (iHc) and the relationship between Pr content and remanence (Br);

FIG. 2 is a graph illustrating the relationship of Pr content-coercivity (iHc)-remanence (Br);

FIG. 3 is a graph illustrating the relationship between Pr content and the degree of magnetic orientation Br/Js;

FIG. 4 is a graph illustrating the relationship between Ga content and coercivity (iHc);

FIG. 5 is a view illustrating processes of a method of manufacturing a material for magnetic anisotropic magnet;

FIG. 6 is a view showing a schematic view illustrating the internal condition of a hot-formed body;

FIG. 7 is a view showing a schematic view illustrating the internal condition of a cylindrical formed-body;

FIG. 8 is a SEM photograph of a Pr-based magnet at 750° C. of pre-heating temperature in hot pressing; and

FIG. 9 is a SEM photograph of a Pr-based magnet at 820° C. of pre-heating temperature in hot pressing.

### DETAILED DESCRIPTION OF THE PREFERRED EMBODIMENTS

An embodiment of the present invention is described hereafter in detail.

### [1. Material for Magnetic Anisotropic Magnet]

A material for magnetic anisotropic magnet according to the present invention has the following configuration.

### [1.1 Composition]

The material for magnetic anisotropic magnet according to the present invention has a Pr-T-B—Ga-based composition. That is, the material for magnetic anisotropic magnet according to the present invention contains a predetermined amount of Pr, B, and Ga and the balances are T and inevitable impurities. The reason of range and limit of each element is as follows.

### [1.1.1 Main Component]

### (1) Pr: 13.0 to 15.0 Atomic Percent

When the Pr content is small, the coercivity (iHc) extremely decreases. Further, in the hot plastic working, a workpiece does not have sufficient fluidity, such that the deformation process is difficult. In addition, when the Pr content is small, the degree of magnetic orientation (Br/Js), which is described below, decreases. Therefore, the Pr content needs to be 13.0 atomic percent or more. The Pr content is more preferably 13.5 atomic percent or more.

In contrast, when the Pr content is excessive, the remanence (Br) extremely decreases. Further, in the hot plastic working, the workpiece is easily sintered-stuck to a mold. In addition, when the Pr content is excessive, the degree of magnetic orientation (Br/Js) decreases. Therefore, the Pr content should be 15.0 atomic percent or less. The Pr content is preferably 14.5 atomic percent or less, and more preferably 14.0 atomic percent or less.

### (2) B: 4.5 to 6.5 Atomic Percent

When the B content is small, the crystal grains of the material for magnetic anisotropic magnet are coarsened, such that good orientation of the crystal grains cannot be obtained. Therefore, the B content needs to be 4.5 atomic percent or more. It is preferable that the B content is 5.0 atomic percent or more to improve the coercivity without decreasing the remanence.

In contrast, when the B content is excessive, a B-rich phase, such as hard and brittle PrFeB₄, is created on the crystal boundaries, such that the orientation of the crystal grains becomes easy to be unstable. Therefore, the B content needs to be 6.5 atomic percent or less. It is preferable that the B content is 6.0 atomic percent or less to improve the coercivity without decreasing the remanence.

### (3) Ga: 0.1 to 0.7 Atomic Percent

When the Ga content is small, the coercivity (iHc) decreases. Therefore, the Ga content needs to be 0.1 atomic percent or more. The Ga content is preferably 0.15 atomic percent or more, and more preferably 0.2 atomic percent or more. It is preferable that the Ga content is 0.4 atomic percent or more to improve the coercivity.

In contrast, when the Ga content is excessive, the coercivity (iHc) decreases on the contrary. Further, since Ga is expensive, unnecessarily adding Ga increases cost. Therefore, the Ga content needs to be 0.7 atomic percent or less. It is preferable that the Ga content is 0.5 atomic percent or less to improve the coercivity.

### (4) T and Inevitable Impurities

The balances, other than Pr, B, and Ga, are T and inevitable impurities.

The T may be formed of only Fe or a portion of Fe may be substituted by Co.

When a portion of Fe is substituted by Co, corrosion resistance and thermal stability are improved. However, when the amount of substitution of Fe by Co is excessive, the saturation magnetic flux density and the coercivity are decreased. Therefore, it is preferable that the amount of Co content to the entire amount of elements in the material for magnetic anisotropic magnet is 6.0 atomic percent or less.

### [1.1.2 Subsidiary Element]

### (1) Nd

A portion of Pr may be substituted by Nd. However, when the Nd content is excessive, the coercivity decreases. Further, the melting point of the grain boundary phase increases, such that the degree of magnetic orientation also decreases. Therefore, when Nd is contained, it is preferable that the total amount of Pr and Nd is 13.0 to 15.0 atomic percent while a portion of Pr is substituted by Nd so that the Pr content may become 50 atomic percent or more of all the rare-earth elements.

In detail, it is preferable that the Nd content to the total amount of elements in the material for magnetic anisotropic magnet is 6.0 atomic percent or less. The Nd content is preferably 5.0 atomic percent or less, more preferably 4.0 atomic percent or less, and more preferably 2.0 atomic percent or less.

### (2) Dy and Tb

A portion of Pr may be substituted by at least one element that is selected from a group of Dy and Tb. Further, when both of Pr and Nd are contained, a portion of Pr and/or Nd may be substituted by at least one element selected from a group of Dy and Tb.

When a portion of Pr (and Nd) is substituted by Dy and/or Tb, the magnetic anisotropy increases and the coercivity is improved. Accordingly, the material for magnetic anisotropic magnet containing Dy and/or Tb is suitable for a magnet material that is used at high temperature.

To improve the coercivity, it is preferable that the total amount of Pr (and Nd), Dy, and Tb is 13.0 to 15.0 atomic percent while the Dy and. Tb contents to the total amount of elements in the material for magnetic anisotropic magnet are each 1.0 atomic percent or more.

On the other hand, when the substitution amounts of Dy and/or Tb are excessive, the degree of magnetic orientation may be decreased. Therefore, it is preferable that the total amount of Pr (and Nd), Dy, and Tb is 13.0 to 15.0 atomic percent while the Dy and Tb contents to the total amount of elements in the material for magnetic anisotropic magnet are each 2.0 atomic percent or less.

In addition to substitution by Nd, or instead of that, when substituted by Dy and/or Tb, the total amount of Pr is preferably above 50.0 atomic percent or more of all the rare-earth elements.

### (3) Cu and Al

Instead of substituting any one or more of Dy and Tb for a portion of Pr (and Nd), or in addition to that, the material for magnetic anisotropic magnet may further contain at least one element selected from a group of Cu and Al.

When Cu and/or Al are added in the material for magnetic anisotropic magnet having a predetermined composition, the coercivity is improved. The reason is considered as follows: the melting points of the grain boundary phase is dropped by adding Cu and/or Al, causing the grain boundary phase to be formed uniformly around the main phase and; it becomes correspondingly difficult to receive a magnetic field from the outside. When the Cu and Al contents are small, magnetic properties of the main phase are not damaged by addition of them.

On the other hand, when the Cu and Al contents are excessive, the remanence is decreased. Therefore, when only Cu is added, the Cu content is preferably 1.0 atomic percent or less and more preferably 0.5 atomic percent or less. Similarly, when only Al is added, the Al content is preferably 1.0 atomic percent or less and more preferably 0.5 atomic percent or less.

Further, when both of Cu and Al are added, the total amount of Cu and Al contents is preferably 2.0 atomic percent or less and more preferably 1.5 atomic percent or less.

### [1.2 Structure]

The material for magnetic anisotropic magnet according to the present invention can be obtained by rapidly-cooling a molten alloy having the above composition, pulverizing the ribbon obtained by the rapid-cooling, cold-forming the alloy powder obtained by the pulverizing, hot-forming the cold-formed body, and performing hot plastic working to the hot-formed body. As a result, the material for magnetic anisotropic magnet becomes a polycrystalline body having the crystal grains formed by the main phase (R₂T₁₄B phase (R is a rare-earth element)) and grain boundary phase surrounding the crystal grains.

By optimizing the composition and manufacturing conditions, which is described below, it is possible to improve the remanence while keeping the coercivity high. The reason is considered as follows: the degree of orientation of the axis of easy magnetization is improved without coarsening the crystal grains and without increasing the oxygen content.

The crystal grain diameter of the main phase affects the coercivity. In general, the smaller the crystal grain diameter of the main phase is, the larger the coercivity becomes. In order to achieve high coercivity, the crystal grain diameter is preferably 500 nm or less. The crystal grain diameter is more preferably 300 nm or less and more preferably 200 nm or less.

The “crystal grain diameter” herein implies a value that is obtained by:

(a) photographing the ab surface of the crystal (a surface parallel with the pressing direction, e.g., the longitudinal cross section of an extruded cylindrical magnet),

(b) directly drawing one or plural lines across a total of one hundred crystal grains on the photographed image, perpendicular to the pressing direction, and

(c) dividing the total length of the lines crossing the hundred crystal grains into one hundred.

### [1.3 Degree of Magnetic Orientation]

The degree of magnetic orientation implies a value that is defined by remanence (Br)/saturation magnetic flux density (Js). Further, the saturation magnetic flux density (Js) implies a force of spontaneous magnetization of a magnetic body, in other words, a value where magnetization does not increase when a magnetic field is applied to the magnetic body from the outside.

In the case of a specimen in which the axis of easy magnetization (c-axis) of the R₂Fe₁₄B crystal (R is rare-earth element) is completely orientated, even if the external magnetic field is removed after magnetization is once performed up to the saturation magnetic flux density Js, it is expected that the remanence Br almost becomes the same as Js. That is, the degree of magnetic orientation becomes 1 in a completely orientated specimen.

On the other hand, in the case of a specimen of which the axis of easy magnetization is inclined at a predetermined angle, even though the saturation magnetic flux density is the same as the completely orientated specimen, the axis of easy magnetization considerably rotates during reduction of the external magnetic field, thereby decreasing magnetization. As a result, Js is larger than Br.

In the material for magnetic anisotropic magnet according to the present invention, the degree of magnetic orientation becomes 0.90 or more by optimizing the composition and manufacturing conditions. Further, the degree of magnetic orientation becomes 0.95 or more by optimizing the composition and manufacturing conditions.

### [2. Method of Manufacturing Material for Magnetic Anisotropic Magnet]

A method of manufacturing a material for magnetic anisotropic magnet according to the present invention includes a dissolving/rapid-cooling/pulverizing process, a cold-forming process, a hot-forming process, and a hot plastic working process.

### [2.1 Dissolving/Rapid-Cooling/Pulverizing Process]

The dissolving/rapid-cooling/pulverizing process is a process that dissolves an alloy having a predetermined composition, obtains a ribbon by rapidly-cooling the molten metal, and pulverizes the obtained ribbon.

The method of dissolving a raw material is not specifically limited and may be a method that can obtain a molten metal that is uniform in composition and has fluidity where rapid-cooling solidification is possible. In the case of the material for magnetic anisotropic magnet according to the present invention, it is preferable that the temperature of the molten metal is 1000° C. or more.

The rapid-cooling of the molten metal is generally performed by dropping the molten metal to a rotating roll (Cu roll) having high heat-removal property. The cooling speed of the molten metal can be controlled according to the circumferential velocity of the rotating roll and the amount of molten metal dropped. The circumferential velocity is generally approximately 10 to 30 m/s.

By pulverizing the ribbon obtained by the rapid-cooling, alloy powder in a flake form composed of fine crystal grains of approximately 20 nm is obtained.

### [2.2 Cold-Forming Process]

The cold-forming process is a process that cold-forms the alloy powder obtained by the rapid-cooling and the pulverizing.

The cold-forming is performed by filling the alloy powder in a mold at a room temperature and pressing it with a punch.

In general, the more the forming pressure increases, the higher is the possibility to obtain cold-formed body having higher density. However, when the forming pressure is above a predetermine level, the density of the cold-formed body is saturated, such that unnecessarily high pressing is not preferable. It is preferable to appropriately select the forming pressure, depending on the composition and the size of powder etc.

The pressing time is sufficient to be above a time where the density of the cold-formed body is saturated, which is generally 1 to 5 seconds.

### [2.3 Hot-Forming Process]

The hot-forming process is a process that hot-presses and densifies the cold-formed body.

The hot-forming process is not specifically limited and may be any method that causes air holes remaining in the cold-formed body to disappear, thus allowing the cold-formed body to be densified. For the hot-forming, industrially, so-called hot press method which presses a heated cold-formed body in a mold with a punch is preferable.

There are methods of hot-forming using the hot press method as follows, in detail,

(1) a first method of inserting a cold-formed body into a mold and then applying a predetermined pressure to the cold-formed body for a predetermined time before or after the temperature of the cold-formed body and the mold reaches a predetermined temperature, or while the temperature increases, and

(2) a second method of pre-heating the cold-formed body, inserting the pre-heated cold-formed body into a mold heated at a predetermined temperature, and then applying a predetermined pressure to the cold-formed body for a predetermined time.

In particular, since the second method makes it possible to continuously heat and press the cold-formed body, it is useful as an industrial manufacturing method. Further, it has an advantage of further improving the degree of magnetic orientation by optimizing conditions of the pre-heating.

Optimal conditions for the hot press are selected, depending on the composition or required properties.

In general, when the temperature in the hot press is excessively low, the grain boundary phase is not sufficiently liquefied. As a result, densification is not sufficient or, occasionally, cracks may occur in the formed-body after the hot-forming process. Therefore, it is preferable that the temperature of the hot press is 750° C. or more.

In contrast, when the temperature in the hot process is excessively high, the crystal grains are coarsened and the magnetic properties are decreased. Therefore, it is preferable that the temperature in the hot process is 850° C. or less.

In general, the higher the pressure during the hot press is, the more the densification of the formed-body proceeds. Meanwhile, excessive pressing is not practically advantageous because the effect is saturated. It is preferable to appropriately select the pressure during the hot press, depending on the composition and the size of powder and temperature conditions etc.

In general, the longer the pressurizing time is, the more the densification of the formed-body proceeds. Meanwhile, the pressurizing time longer than necessary causes the crystal grains to grow and the magnetic properties to decrease. It is preferable to select the pressing time, depending on the composition, the size of powder, and temperature conditions, etc.

The atmosphere of the hot press may be any one of an inert atmosphere, an oxidation atmosphere, and a reduction atmosphere. However, an increase of oxygen content decreases the magnetic properties. Therefore, it is preferable that the atmosphere of the hot press is the inert atmosphere or the reduction atmosphere.

In the case of performing the hot press in accordance with the second method, when the pre-heating temperature is excessively low, the grain boundary phase is not sufficiently liquefied during the hot press. As a result, crack may occur in the formed-body during the hot-forming. On the contrary, in order to avoid the crack, after inserting the formed-body into the mold, holding it until it reaches a predetermined temperature decreases productivity. Therefore, it is preferable that the pre-heating temperature is 500° C. or more. More preferably, the pre-heating temperature is 600° C. or more, and more preferably 700° C. or more.

In contrast, when the pre-heating temperature is excessively high, the crystal grains are coarsened. Further, in the case that the pre-heating is performed in the atmosphere, the higher the pre-heating temperature is, the more oxidized the material is, such that the oxygen content increases. Therefore, it is preferable that the pre-heating temperature is 850° C. or less. More preferably, the pre-heating temperature is 800° C. or less and more preferably 780° C. or less.

The pre-heating time may be a time in which the formed-body reaches the predetermined temperature. When the pre-heating time is excessively short, the grain boundary phase is not liquefied, causing crack to occur during the hot-forming. In contrast, excessive pre-heating becomes a reason that causes the crystal grains to grow. It is preferable to select an appropriate pre-heating time, depending on the size of the formed-body and the pre-heating temperature. In general, it is preferable that the larger the size of the formed-body is, the longer the pre-heating time is selected. Further, it is preferable that the lower the pre-heating temperature is, the longer the pre-heating time is selected.

The atmosphere of the pre-heating may be any one of an inert atmosphere, an oxidation atmosphere, and a reduction atmosphere. However, an increase of oxygen content decreases the magnetic properties. Therefore, it is preferable that the atmosphere of the pre-heating is the inert atmosphere or the reduction atmosphere.

### [2.4 Hot Plastic Working]

The hot plastic working is a process that plastically deforms the densified hot-formed body into a predetermined shape.

The hot plastic working is not specifically limited and can use various methods according to the objects.

There are methods for hot plastic working, in detail,

(1) hot extrusion (including backward extrusion and forward extrusion) and

(2) hot upsetting.

Considering improvement of the magnetic orientation, the hot extrusion is particularly useful in the methods for hot plastic working.

The processing temperature is temperature where the plastic deformation is possible without crack occurring in the formed-body. In general, when the processing temperature is excessively low, the grain boundary phase is not sufficiently liquefied, such that crack may occur in the formed-body. Therefore, it is preferable that the processing temperature is 750° C. or more.

In contrast, when the processing temperature is excessively high, the crystal grains are coarsened and the magnetic properties are decreased. Therefore, it is preferable that the processing temperature is 850° C. or less.

The atmosphere of the hot plastic working may be any one of an inert atmosphere, an oxidation atmosphere, and a reduction atmosphere. However, an increase of oxygen content decreases the magnetic properties. Therefore, it is preferable that the atmosphere of the hot plastic working is the inert atmosphere or the reduction atmosphere.

After the hot plastic working, by performing a post-process if necessary, a magnet material having desired composition and shape is obtained.

### [3. Effect of Material for Magnetic Anisotropic Magnet and Effect of Method of Manufacturing the Same]

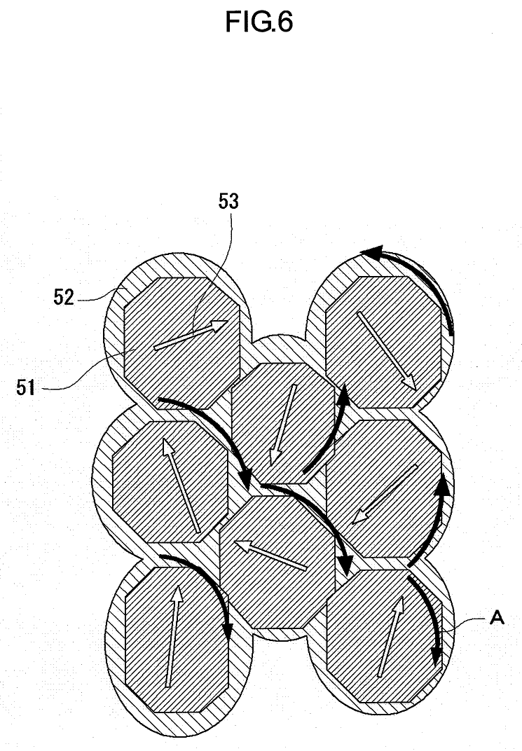

The alloy powder obtained by rapidly-cooling/solidifying and pulverizing is cold-formed, thus the cold-formed body is obtained, and then the cold-formed body is hot-formed, with the result that the dense hot-formed body is obtained. FIG. 6 is a schematic view illustrating the internal condition of the hot-formed body. As shown in detail in FIG. 6, the inside of the hot-formed body is composed of crystal grains 51 and grain boundary phases 52. When the temperature of the hot-formed body is over approximately 700° C. during the hot-forming, the grain boundary phase 52 starts to liquefy. Further, when the heating temperature is over 750° C., the crystal grain 51 becomes surrounded by the liquefied grain boundary phase 52.

In this state, the crystal grain 51 can rotate in the direction indicated by a black arrow denoted by A. However, since the amount of compressive deformation is small during the hot processing, axes of easy magnetization 53 (white arrows) existing in the crystal grains 51 have such directions of magnetization (i.e. directions of N-poles and S-poles) that remain non-uniform state as they are (isotropic state). Therefore, in general, the axes of easy magnetization 53 do not become such state that is uniform in a predetermined direction (anisotropic state).

Next, by performing the hot plastic working to the obtained hot-formed body, the hot-formed body is plastically deformed and a magnet material having a desired shape is obtained.

When the hot-formed body is heated, the grain boundary phases liquefy and the crystal grains can rotate. In this state, when the hot plastic working is performed, the crystal grains are plastically deformed while being compressed in the pressing direction and the axes of easy magnetization are oriented in the pressing direction.

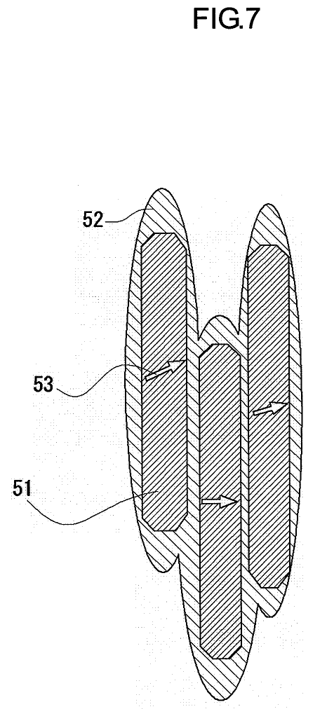

For example, by performing hot backward extrusion to the hot-formed body, a cylindrical formed-body with a bottom is obtained. FIG. 7 is a schematic view illustrating the internal condition of the cylindrical formed-body. The right direction in FIG. 7 is the radial direction of the cylindrical formed-body.

In the case that the cylindrical formed-body is manufactured by the hot backward extrusion, a punch is inserted along an axial direction, but the pressing direction of the material is the radial direction. Therefore, the backward extrusion is performed, so that the crystal grains 51 surrounded by the liquefied grain boundary phases 52 are compressed in the radial direction. Further, simultaneously, the axes of easy magnetization 53 rotate so as to be oriented in the radial direction. As a result, as shown in FIG. 7, the cylindrical formed-body having such axes of easy magnetization 53 that are oriented in the radial direction is obtained.

Since the material for magnetic anisotropic magnet according to the present invention contains Pr as the main component, it has high magnetic orientation (axes of easy magnetization 53 are easily arranged). It is assumed that the reason why the magnetic orientation increases is that the melting point of the grain boundary phase 52 drops to relatively low temperature when Pr is contained as the main component. That is, it is considered to be because of the specific orientation mechanism of Pr in which the crystal grains 51 easily rotate by performing the hot plastic working at a high temperature.

That is, according to the material for magnetic anisotropic magnet of the present invention, it is possible to improve coercivity without decreasing the remanence, by utilizing the characteristics of the element Pr and the specific orientation mechanism of Pr during the hot plastic working.

Further, in the case that the hot-forming is performed by the hot press method, it is possible to further improve the remanence while keeping the coercivity high, by optimizing the manufacturing conditions. In particular, by pre-heating the formed-body at a predetermined temperature and performing hot press to the formed-body in a mold heated at a predetermined temperature, with the result that the coercivity is improved and a magnet material having the degree of magnetic orientation of 0.95 or more is obtained.

The reasons are considered as follows:

(1) the pre-heating is performed at a predetermined temperature, so that the hot-formed body, in which numerous nuclei of magnetic particles are created and the crystal grains become fine and uniform, is obtained, and

(2) because of the fine and uniform crystal grains, the axes of easy magnetization are more easily orientated during the hot plastic working.

### EXAMPLES

### Example 1.1

### [1. Manufacturing Specimen]

A molten alloy having a predetermined composition was rapidly-cooled. Then the obtained ribbon was pulverized, thereby alloy powder was obtained. The alloy powder was cold-formed and the cold-formed body was hot-formed. Further, hot plastic working was applied to the hot-formed body, with the result that a material for magnetic anisotropic magnet was obtained.

The composition of the alloy was PrₓFe_{94.05-x}B_{5.5}Ga_{0.45} (x=12.0, 12.5, 13.0, 13.5, 14.0, 14.5, 15.0, 15.5, 16.0, including inevitable impurities).

### [2. Method of Test]

### [2.1 Magnetic Property]

The material for magnetic anisotropic magnet was magnetized and the magnetic properties were measured by using a direct current BH tracer.

### [2.2 Degree of Magnetic Orientation]

The material for magnetic anisotropic magnet was magnetized and the degree of magnetic orientation was measured by using a pulse-typed high-magnetic field meter (magnetic field: 3988 kA/m).

### [3. Result]

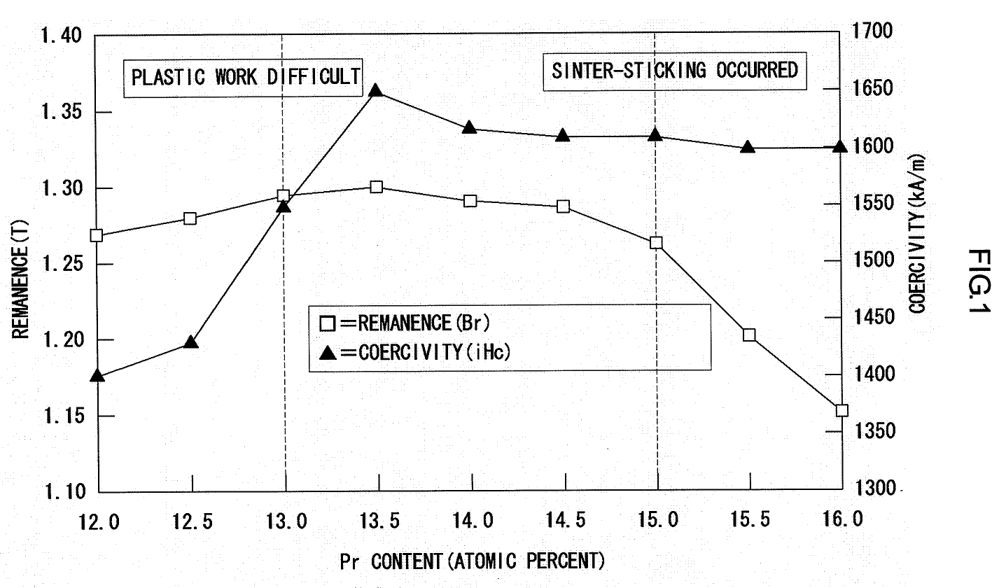

FIG. 1 illustrates the relationship between the Pr content and the coercivity (iHc) and the relationship between the Pr content and the remanence (Br).

It can be seen from FIG. 1 that,

(1) when the Pr content is under 13 atomic percent, the coercivity (iHc) decreases considerably and plastic working is difficult, and

(2) when the Pr content is over 15 atomic percent, the remanence (Br) decreases considerably and sinter-sticking to the mold easily occurs.

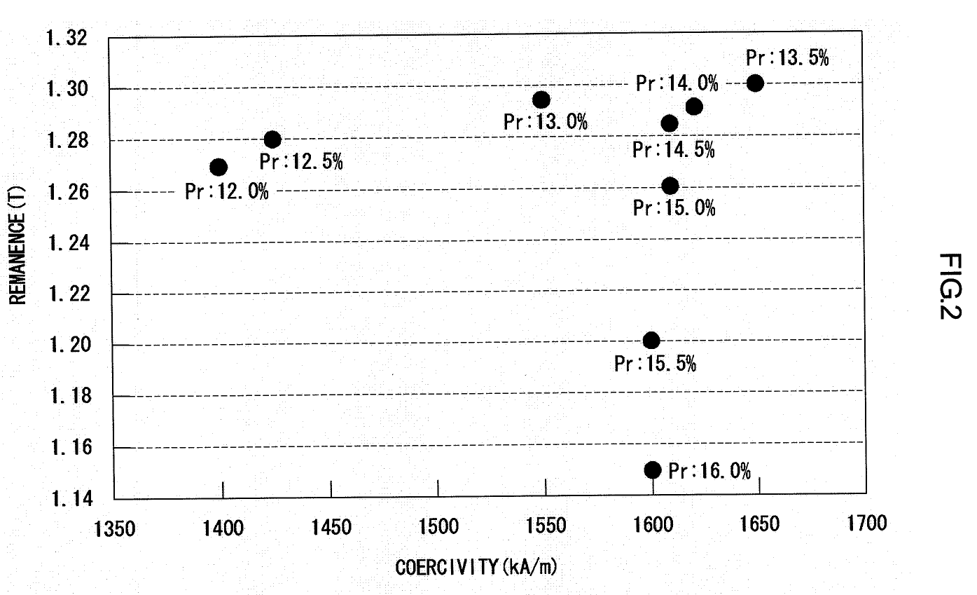

FIG. 2 illustrates the relationship of Pr content-coercivity (iHc)-remanence (Br). It is shown in FIG. 2 that the magnetic property becomes better toward the right upper portion.

It can be seen from FIG. 2 that the Pr content where both of the coercivity and the remanence are excellent is 13.5 to 14.5 atomic percent, and more preferably 13.5 to 14.0 atomic percent.

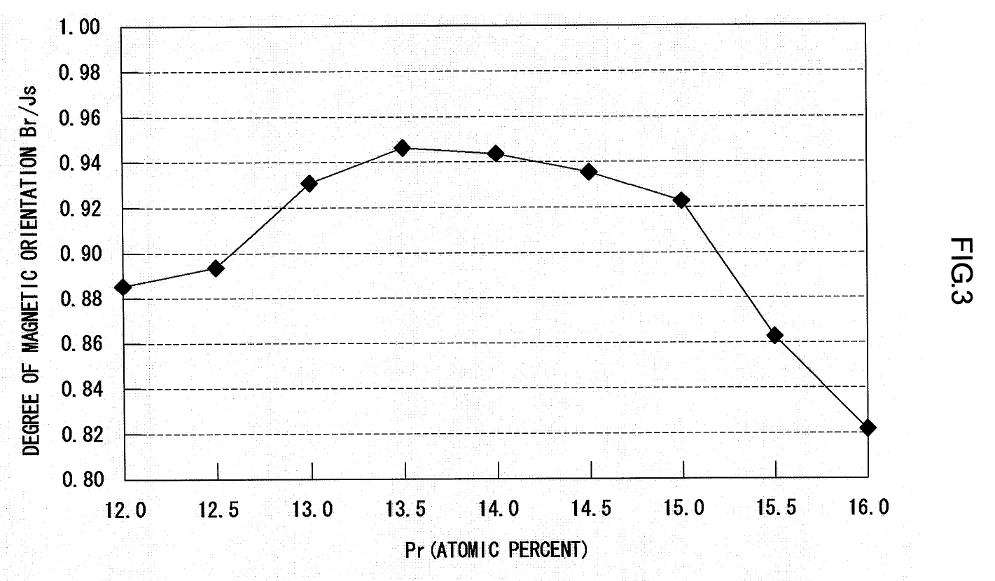

FIG. 3 illustrates the relationship between the Pr content and the degree of magnetic orientation Br/Js.

It can be seen from FIG. 3 that the degree of magnetic orientation decreases at any case when the Pr content is under 13 atomic percent and over 15 atomic percent.

### Example 1.2

### [1. Manufacturing Specimen]

A material for magnetic anisotropic magnet was manufactured in the same method as the example 1.1, except that the composition was Pr_{13.09}Fe_{81.51-y}B_{5.4}Ga_{y} (y=0, 0.1, 0.2, 0.3, 0.4, 0.5, 0.6, 0.7, 0.8, including inevitable impurities).

### [2. Method of Test]

The material for magnetic anisotropic magnet was magnetized and the magnetic properties were measured by using a direct current BH tracer.

### [3. Result]

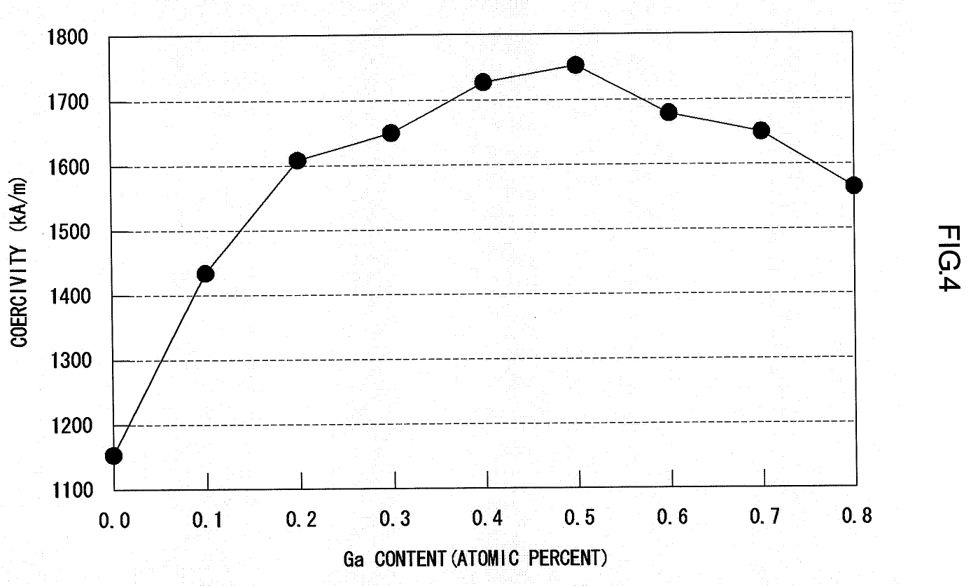

FIG. 4 illustrates the relationship between the Ga content and the coercivity (iHc).

It can be seen from FIG. 4 that,

(1) when the Ga content is under 0.1 atomic percent, the coercivity (iHc) extremely decreases,

(2) when the Ga content is over 0.7 atomic percent, the coercivity (iHc) decreases, and

(3) in order to achieve high coercivity, it is preferable that the Ga content is 0.2 to 0.7 atomic percent and more preferably 0.4 to 0.5 atomic percent.

### Examples 2.1 to 2.21, Comparative Examples 2.1 to 2.5

### [1. Manufacturing Specimen]

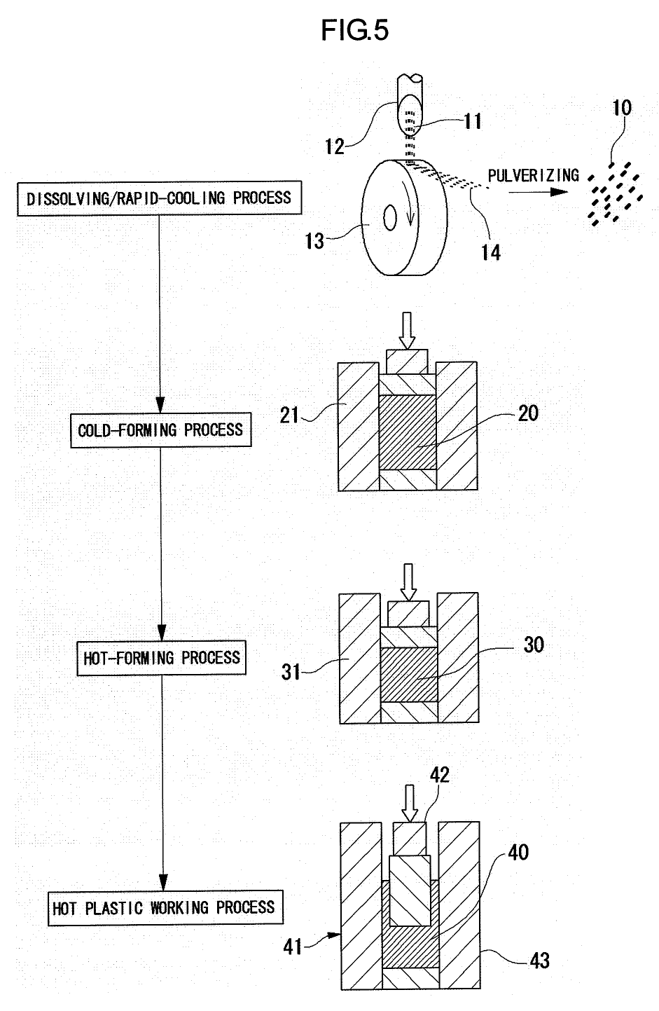

In accordance with the compositions (Examples 2.1 to 2.21, Comparative examples 2.1 to 2.5) shown in Table 1, material for magnetic anisotropic magnets were manufactured by the following manufacturing methods. FIG. 5 illustrates the processes of a method of manufacturing a material for magnetic anisotropic magnet.

### [1.1 Dissolving/Rapid-Cooling/Pulverizing Process]

Predetermined amounts of various components of alloy materials are mixed and dissolved at 1000° C. or more. The molten alloy 11 was dropped and rapidly-cooled from an orifice 12 to a rotating roll 13 having high heat-removal property, and a ribbon 14 was manufactured. The circumferential speed of the rotating roll 13 was 18 to 20 m/s. The ribbon 14 was pulverized, thereby alloy powder 10 of flake form composed of fine crystal grains of 0.02 μm (20 nm) was obtained.

### [1.2 Cold-Forming Process]

Alloy powder 10 of 56 g was set in a cold press 21. The alloy powder was formed in a cylindrical shape by applying pressure of approximately 5.1 t/cm² (5.0×10² MPa) from 1 to 5 seconds, with the result that a cold-formed body 20 (cylindrical formed-body having an outer diameter of 22.8 mm and a height of 30 mm) was obtained.

### [1.3 Hot-Forming Process]

The cold-formed body 20 was set in a hot press 31. The cold-formed body 20 was heated at approximately 800° C. under an Ar-atmosphere and then formed in a cylindrical shape by applying pressure of approximately 4 t/cm² (3.92 MPa) for approximately 20 seconds, with the result that a hot-formed body 30 (cylindrical formed-body having an outer diameter of 22.8 mm and a height of 20 mm) was obtained.

### [1.4 Backward Extrusion]

The hot-formed body 30 was set in a backward extruder 41 and the backward-extruding was performed at approximately 860° C. in the atmosphere, with the result that a material for magnetic anisotropic magnet 40 (cylindrical formed-body having an outer diameter of 22.8 mm, an inner diameter of 18.8 mm, and a height of 40 mm) was obtained.

When the hot-formed body 30 is inserted into a mold 43 and extruded backward (upward in FIG. 5) by a punch 42 smaller in diameter than the hot-formed body 30, the hot-formed body 30 is extruded into the groove between the punch 42 and the mold 43, in the opposite direction to the moving direction of the punch 42. As a result, a cylindrical formed-body 40 with a bottom is obtained.

The bottom of the obtained cylindrical formed-body 40 was cut off, and then the cylindrical formed-body 40 was magnetized in the radial direction, with the result that a ring-shaped magnet was obtained.

### [2. Method of Test]

### [2.1 Composition Analysis]

The composition of the alloy powder was measured by ICP AES.

### [2.2 Degree of Magnetic Orientation]

The degree of magnetic orientation Br/Js of the obtained ring-shaped magnet was measured by using a pulse-typed high-magnetic field meter (magnetic field: 3988 kA/m). The measurement was applied to a disc-shaped specimen having a diameter of approximately 5 mm that was cut off from the side of the magnetized ring-shaped magnet.

### [2.3 Magnetic Property]

Coercivity (iHc) and remanence (Br) of the obtained ring-shaped magnet were measured by using a direct current BH tracer. The measurement was applied to a disc-shaped specimen having a diameter of approximately 5 mm that was cut off from the side of the magnetized ring-shaped magnet, as in the measurement of the degree of magnetic orientation.

Table 1 shows the measured results.

TABLE 1

| | Composition (Atomic percent) | | | | | | | | | | | Magnetic property | |
|---|---|---|---|---|---|---|---|---|---|---|---|---|---|
| | Pr | Nd | Dy | Tb | Fe | Co | B | Ga | Cu | Al | Br/Js | Br (T) | iHc (kA/m) |
| Example 2.1 | 13.55 | — | — | — | bal | 5.95 | 5.76 | 0.55 | — | — | 0.908 | 1.226 | 1667 |
| Example 2.2 | 13.57 | — | — | — | bal | — | 5.69 | 0.43 | — | — | 0.936 | 1.300 | 1672 |
| Example 2.3 | 13.29 | — | — | — | bal | — | 5.51 | 0.42 | — | 0.38 | 0.932 | 1.264 | 1704 |
| Example 2.4 | 13.62 | — | — | — | bal | — | 5.76 | 0.35 | 0.35 | 0.63 | 0.912 | 1.246 | 1720 |
| Example 2.5 | 13.12 | — | 0.12 | — | bal | — | 5.56 | 0.43 | — | — | 0.925 | 1.292 | 1579 |
| Example 2.6 | 13.27 | — | 0.12 | — | bal | — | 4.86 | 0.23 | — | — | 0.946 | 1.204 | 1588 |
| Example 2.7 | 13.36 | — | 0.12 | — | bal | — | 5.57 | 0.43 | — | — | 0.915 | 1.224 | 1624 |
| Example 2.8 | 13.35 | — | 0.13 | — | bal | — | 5.46 | 0.20 | — | — | 0.925 | 1.248 | 1681 |
| Example 2.9 | 13.39 | — | 0.13 | — | bal | — | 5.58 | 0.39 | — | — | 0.932 | 1.269 | 1724 |
| Example 2.10 | 13.32 | — | 0.31 | — | bal | — | 5.76 | 0.43 | — | 0.46 | 0.910 | 1.235 | 1786 |
| Example 2.11 | 13.17 | — | 0.61 | — | bal | — | 5.78 | 0.41 | 0.35 | 0.63 | 0.906 | 1.291 | 1909 |
| Example 2.12 | 12.65 | — | 0.62 | — | bal | 5.92 | 5.41 | 0.55 | — | — | 0.945 | 1.269 | 1681 |
| Example 2.13 | 12.72 | — | 0.62 | — | bal | 2.99 | 5.53 | 0.41 | 0.33 | — | 0.938 | 1.258 | 1782 |
| Example 2.14 | 12.46 | — | 0.99 | — | bal | — | 5.53 | 0.41 | — | — | 0.920 | 1.205 | 1929 |
| Example 2.15 | 12.21 | — | 1.51 | — | bal | — | 5.66 | 0.43 | — | — | 0.905 | 1.214 | 2007 |
| Example 2.16 | 12.18 | — | 1.52 | — | bal | — | 5.25 | 0.24 | 0.15 | — | 0.934 | 1.202 | 2145 |
| Example 2.17 | 12.15 | — | 1.52 | — | bal | — | 5.36 | 0.25 | — | — | 0.940 | 1.271 | 2118 |
| Example 2.18 | 12.04 | — | 1.53 | — | bal | — | 5.43 | 0.49 | — | — | 0.935 | 1.251 | 2102 |
| Example 2.19 | 12.56 | — | — | 1.04 | bal | — | 5.54 | 0.42 | — | — | 0.942 | 1.240 | 2187 |
| Example 2.20 | 11.02 | 1.35 | 1.47 | — | bal | — | 5.60 | 0.52 | — | — | 0.935 | 1.230 | 2146 |
| Example 2.21 | 9.44 | 1.89 | 1.54 | — | bal | — | 5.56 | 0.54 | — | — | 0.932 | 1.224 | 2134 |
| Comparative | — | 13.64 | — | — | bal | 5.98 | 5.70 | 0.77 | — | — | 0.885 | 1.222 | 1486 |
| Example 2.1 | | | | | | | | | | | | | |
| Comparative | — | 12.70 | 0.63 | — | bal | 6.03 | 5.16 | 0.56 | — | — | 0.890 | 1.255 | 1470 |
| Example 2.2 | | | | | | | | | | | | | |
| Comparative | — | 13.18 | 0.13 | — | bal | — | 5.72 | 0.43 | — | — | 0.883 | 1.299 | 1426 |
| Example 2.3 | | | | | | | | | | | | | |
| Comparative | — | 12.66 | 0.63 | — | bal | 2.95 | 5.39 | 0.58 | — | — | 0.889 | 1.259 | 1498 |
| Example 2.4 | | | | | | | | | | | | | |
| Comparative | — | 13.25 | 0.13 | — | bal | — | 5.49 | 0.41 | — | — | 0.885 | 1.260 | 1441 |
| Example 2.5 | | | | | | | | | | | | | |

### [Examination]

As shown in detail in Table 1, all of the degrees of magnetic orientation Br/Js in the Examples 2.1 to 2.21 are high over 0.9, whereas all of the degrees of magnetic orientation Br/Js in the Comparative examples 2.1 to 2.5 are under 0.9. Further, the residual magnetic flux densities (Br) in the Examples 2.1 to 2.21 are the same as or more than the residual magnetic flux densities (Br) in the Comparative examples 2.1 to 2.5.

This is assumed because the degree of magnetic orientation was improved by the specific orientation mechanism of Pr during the hot plastic working.

All of the coercitivities (iHc) in the Examples 2.1 to 2.21 where Pr is contained as the main component are 1500 kA/m or more. On the other hand, all of the coercitivities (iHc) in the Comparative examples 2.1 to 2.5 where Nd is contained as the main component are under 1500 kA/m. This is because the anisotropic magnetic field of a Pr₂Fe₁₄B-type composition is larger than that of an Nd₂Fe₁₄B-type composition.

Further, since the amount of substitution of Dy or Tb is 1 atomic percent or more in the Examples 2.15 to 2.19, all of the coercitivities (iHc) are 2000 kA/m or more. In particular, since Cu was added in the Example 2.16, the results were good coercivity (iHc).

As a result, it can be seen that the Examples where the amount of substitution of Dy or Tb is 1 atomic percent or more can be used for an object that needs high heat resistance, such as a motor for a vehicle that is driven under a high-temperature environment. However, excessive substitution may have an adverse effect on the degree of magnetic orientation during hot plastic working. Therefore, it is preferable that the amount of substitution is 2.0 atomic percent or less.

Accordingly, in the case that the coercivity is specifically required for use, it is preferable that the amount of substitution of Dy or Tb is 1.0 to 2.0 atomic percent.

Further, comparing the Examples 2.2 to 2.4 that are substantially the same, except for the composition of Cu and Al, it can be seen that the good coercivity (iHc) is obtained in the Examples 2.3 and 2.4 where Cu and Al were added. Similarly, comparing the Examples 2.10 to 2.13 that are substantially the same, except for the composition of Cu and Al, it can be seen that good coercivity (iHc) is obtained in the Examples 2.10, 2.11, and 2.13 where Cu and Al were added.

As a result, it could be seen that the coercivity was increased by adding Cu and Al.

Further, the Examples 2.20 and 2.21 where a portion of Pr was substituted by Nd had equal or more magnetic properties than the Example 2.18 where the total amount of rare-earth elements is substantially the same as those in the above Examples.

It could be seen from the above result that the coercivity was improved by the material for magnetic anisotropic magnets relating to the Examples 2.1 to 2.21, without decreasing the remanence. Further, it could be seen that a material for magnetic anisotropic magnet according to the present invention could be used for a motor that requires high magnetic force and heat resistance.

### Examples 3.1 to 3.9, Comparative Examples 3.1 to 3.9

### [1. Manufacturing Specimen]

Pr-based (Examples 3.1 to 3.9) alloy powder and Nd-based (Comparative examples 3.1 to 3.9) alloy powder were produced by the rapid-cooling/solidifying and pulverizing method. The composition of the Pr-based alloy powder was 12.85Pr-5.36B-0.42Ga-bal.Fe (atomic percent). Further, the composition of the Nd-based alloy powder was 12.87Nd-5.38B-0.44Ga-bal.Fe (atomic percent).

By performing cold-forming, hot-forming, and hot plastic working to the alloy powder, a cylindrical formed-body was obtained. The hot-forming was performed by pre-heating the cold-formed body at 500 to 820° C. under an Ar-atmosphere and then pressing the pre-heated formed-body in a mold heated at 815 to 850° C. The conditions of the cold-forming and hot plastic working were the same as the Examples 2.1 to 2.21.

The bottom of the obtained cylindrical formed-body was cut off, and then the cylindrical formed-body was magnetized in the radial direction, with the result that a ring-shaped magnet was obtained.

### [2. Method of Test]

In accordance with the same order as the Examples to 2.21, the magnetic property and the degree of magnetic orientation were measured.

Table 2 shows the result. Table 2 further shows hot-forming conditions.

TABLE 2

| | | Hot-Forming Condition | | | | | | Crystal |
|---|---|---|---|---|---|---|---|---|
| | | Pre-Heating | Die | Magnetic Property | | | | grain |
| | | Temperature | Temperature | Br (T) | iHc | (BH) max | | diameter |
| | Composition | (° C.) | (° C.) | (T) | (kA/m) | (kJ/cm³) | Br/Js | (nm) |
| Example 3.1 | Pr-based | 500 | 850 | 1.26 | 1597.47 | 304.64 | 0.941 | 136 |
| Example 3.2 | magnet | | | 1.27 | 1588.68 | 304.94 | 0.942 | 124 |
| Example 3.3 | | | | 1.25 | 1637.88 | 301.19 | 0.936 | 169 |
| Example 3.4 | | 750 | 815 | 1.30 | 1469.62 | 328.04 | 0.952 | 200 |
| Example 3.5 | | | | 1.30 | 1535.73 | 324.71 | 0.955 | 228 |
| Example 3.6 | | | | 1.30 | 1492.60 | 328.09 | 0.953 | 237 |
| Example 3.7 | | 820 | 815 | 1.25 | 1359.19 | 297.17 | 0.942 | 705 |
| Example 3.8 | | | | 1.26 | 1330.48 | 303.93 | 0.938 | 797 |
| Example 3.9 | | | | 1.26 | 1405.84 | 302.74 | 0.945 | 897 |
| Comparative | Nd-based | 500 | 850 | 1.24 | 1489.02 | 292.69 | 0.896 | 154 |
| Example 3.1 | magnet | | | | | | | |
| Comparative | | | | 1.23 | 1433.20 | 284.30 | 0.892 | 149 |
| Example 3.2 | | | | | | | | |
| Comparative | | | | 1.23 | 1505.66 | 286.48 | 0.894 | 203 |
| Example 3.3 | | | | | | | | |
| Comparative | | 750 | 815 | 1.22 | 1428.47 | 282.93 | 0.888 | 247 |
| Example 3.4 | | | | | | | | |
| Comparative | | | | 1.24 | 1373.14 | 288.11 | 0.894 | 232 |
| Example 3.5 | | | | | | | | |
| Comparative | | | | 1.24 | 1419.05 | 285.85 | 0.897 | 272 |
| Example 3.6 | | | | | | | | |
| Comparative | | 820 | 815 | 1.23 | 1373.81 | 284.31 | 0.897 | 760 |
| Example 3.7 | | | | | | | | |
| Comparative | | | | 1.24 | 1342.07 | 290.21 | 0.899 | 802 |
| Example 3.8 | | | | | | | | |
| Comparative | | | | 1.23 | 1320.44 | 287.15 | 0.896 | 865 |
| Example 3.9 | | | | | | | | |

### [3. Result]

It can be seen from Table 2 that,

(1) in the Pr-based magnet, the maximum energy product (BH)ₘₐₓ is at the maximum and the degree of magnetic orientation is over 0.95 at the pre-heating temperature of 750° C. and mold temperature of 815° C., and

(2) the maximum energy product (BH)ₘₐₓ of the Nd-based magnet is not practically affected by the pre-heating temperature and the degree of magnetic orientation of the Nd-based magnet is under 0.90.

In the Pr-based magnet, it is considered that the maximum energy product decreases when the pre-heating temperature is excessively high because the crystal grains are coarsened and the oxygen content in the magnet increases. On the other hand, in the Nd-based magnet, it is considered that the pre-heating temperature does not practically affect the maximum energy product because the improvement of the degree of magnetic orientation due to increase of the pre-heating temperature is offset by decrease of the coercivity due to coarsening of the crystal grains.

In both of the Pr-based magnet and the Nd-based magnet, when the pre-heating temperature was under 500° C., the grain boundary phases did not liquefy, such that cracks frequently occurred in the work after the hot-forming, and it was difficult to form a magnet.

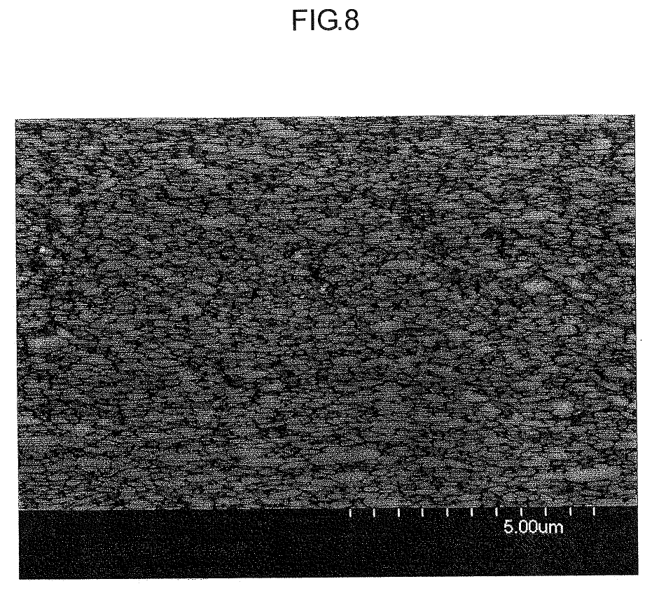

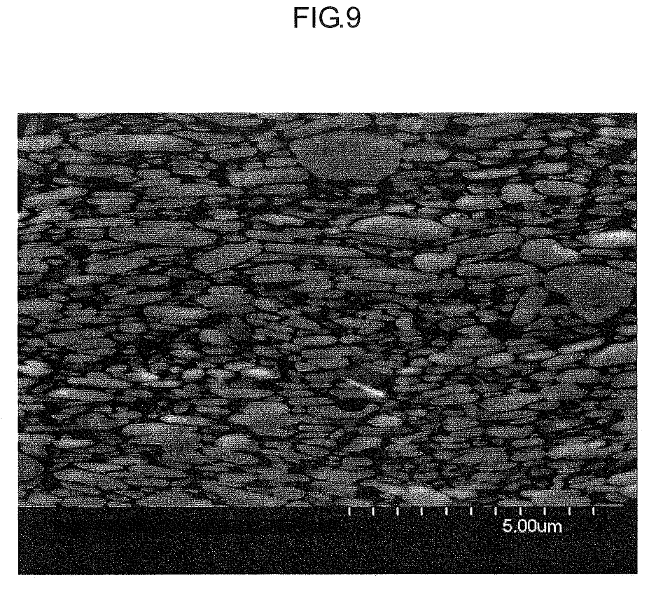

FIG. 8 and FIG. 9 show SEM photographs of the Pr-based magnet pre-heated at 750° C. and 820° C., respectively. At the pre-heating temperature of 820° C., rough and large particles were contained and the diameter of the crystal grain was 700 nm or more. On the other hand, at the pre-heating temperature of 750° C., rough and large particles were not contained and the diameter of the crystal grain was approximately 200 nm. It is considered that a high magnetic property is obtained because the crystal grains become uniform and fine by performing the pre-heating at a temperature of 750° C.

From the above result, it could be seen that, the Pr-based magnet of which the melting point of grain boundary phase was lower than the Nd-based magnet had appropriate pre-heating temperature at which the magnet could be formed and reduction of magnetic property was small.

A material for magnetic anisotropic magnet according to the present invention is designed to improve coercivity without decreasing remanence. Therefore, the present invention can be appropriately used particularly for motors for hybrid vehicles that require high coercivity and remanence. The reason is as follows: since these motors are driven under a high-temperature environment, the material for magnetic anisotropic magnet requires heat resistance and, further, miniaturization of the parts of the vehicles requires high rotational force (magnetic force).

What is claimed is:

1. A material for magnetic anisotropic magnet, comprising:
(1) a Pr-T-B—Ga-based composition containing Pr: 13.0 to 15.0 atomic percent, B: 4.5 to 6.5 atomic percent, Ga: 0.1 to 0.7 atomic percent, and the balance of T and inevitable impurities, wherein T is obtained by substituting Co for Fe or a portion of Fe,
(2) the material for magnetic anisotropic magnet is obtained by rapidly-cooling a molten alloy having the composition, pulverizing the ribbon obtained by the rapid-cooling, cold-forming the alloy powder obtained by the pulverizing, hot-forming the cold-formed body, and performing hot plastic working to the hot-formed body, and
(3) the degree of magnetic orientation of the material for magnetic anisotropic magnet, which is defined by remanence (Br)/saturation magnetic flux density (Js), is 0.9 or more.

2. The material for magnetic anisotropic magnet according to claim 1, wherein a portion of Pr is substituted by at least one element selected from a group of Dy and Tb.

3. The material for magnetic anisotropic magnet according to claim 1, further comprising at least one element selected from a group of Cu and Al.

4. The material for magnetic anisotropic magnet according to claim 1, wherein a portion of Pr is substituted by at least one element selected from a group of Dy and Tb,
the material for magnetic anisotropic magnet further comprising at least one element selected from a group of Cu and Al.

5. The material for magnetic anisotropic magnet according to claim 1, wherein a portion of Pr is substituted by Nd and Pr is 50 atomic percent or more of all the rare-earth elements.

6. The material for magnetic anisotropic magnet according to claim 5, wherein a portion of Pr and/or Nd is substituted by at least one element selected from a group of Dy and Tb.

7. The material for magnetic anisotropic magnet according to claim 5, further comprising at least one element selected from a group of Cu and Al.

8. The material for magnetic anisotropic magnet according to claim 5, wherein a portion of Pr and/or Nd is substituted by at least one element selected from a group of Dy and Tb,
the material for magnetic anisotropic magnet further comprising at least one element selected from a group of Cu and Al.

9. The material for magnetic anisotropic magnet according to claim 1, wherein the degree of magnetic orientation is 0.95 or more.

10. The material for magnetic anisotropic magnet according to claim 1, wherein the diameter of a crystal grain is 500 nm or less.

11. The material for magnetic anisotropic magnet according to claim 1, wherein the degree of magnetic orientation is 0.95 or more and the diameter of the crystal grain is 500 nm or less.

12. The material for magnetic anisotropic magnet according to claim 1, wherein the hot plastic working is hot extrusion.

13. The material for magnetic anisotropic magnet according to claim 9, wherein the hot plastic working is hot extrusion.

14. The material for magnetic anisotropic magnet according to claim 10, wherein the hot plastic working is hot extrusion.

15. The material for magnetic anisotropic magnet according to claim 11, wherein the hot plastic working is hot extrusion.
